(19) United States
(12) Patent Application Publication
(10) Pub. No.: US 2012/0226503 A1
(43) Pub. Date: Sep. 6, 2012

(54) INFORMATION PROCESSING APPARATUS AND METHOD

(75) Inventors: Masahito Sano, Fuji-shi (JP); Kiyomitu Yamaguchi, Izunokuni-shi (JP); Koji Kurosawa, Setagaya-ku (JP)

(73) Assignee: TOSHIBA TEC KABUSHIKI KAISHA, Tokyo (JP)

(21) Appl. No.: 13/398,291

(22) Filed: Feb. 16, 2012

(30) Foreign Application Priority Data
Mar. 4, 2011 (JP) 2011-048076

(51) Int. Cl. G10L 21/00

(52) U.S. Cl. 704/275; 704/E21.001

(57) ABSTRACT

An information processing apparatus comprising an information output unit configured to switch a plurality of languages at each given time interval while output a guidance information set by the plurality of languages, a response detection unit configured to detect a response to the guidance information when the guidance information is output while the languages are switched and a processing language determination unit configured to take the language which detect the response to the guidance information as a processing language.

### CROSS-REFERENCE TO RELATED APPLICATION

This discourse is based upon and claims the priority from prior Japanese Patent Application No. 2011-048076, filed on Mar. 4, 2011, which is incorporated herein by reference in its entirety.

### FIELD

Embodiments described herein relate to an information processing apparatus and method.

### BACKGROUND

At present, an information terminal for providing guidance, advertisement, offer and response in more than two languages for a user facing the terminal is known.

### BRIEF DESCRIPTION OF THE DRAWINGS

FIG. 1 is a perspective view illustrating the appearance of an information processing apparatus according to an embodiment;

FIG. 2 is a block diagram illustrating the structure of the electrical equipment system of an information providing device;

FIG. 3 is a functional block diagram illustrating the structure of an assist device;

FIG. 4 is a functional block diagram illustrating the structure of a figure determination unit;

FIG. 5 is a schematic diagram illustrating an example of voice guidance;

FIG. 6 is a schematic diagram illustrating an example of a tone or diction setting corresponding to an attribute;

FIG. 7 is a schematic diagram illustrating the language switching processing of the information processing apparatus;

FIG. 8 is a functional block diagram illustrating the functional components for the language switching processing;

FIG. 9 is a flow chart of the language switching process; and

FIG. 10 is a schematic diagram illustrating an example of an advertisement content setting corresponding to the attribute.

### DETAILED DESCRIPTION

According to one embodiment, an information processing apparatus comprising: an information output unit configured to switch a plurality of languages at each given time interval while output a guidance information set by the plurality of languages, a response detection unit configured to detect a response to the guidance information when the guidance information is output while the languages are switched and a processing language determination unit configured to take the language which detect the response to the guidance information as a processing language.

According to one embodiment, a method comprising: switching a plurality of languages at each given time interval while outputting a guidance information set by the plurality of languages, detecting a response to the guidance information when the guidance information is output while the languages are switched and taking the language which detect the response to the guidance information as a processing language.

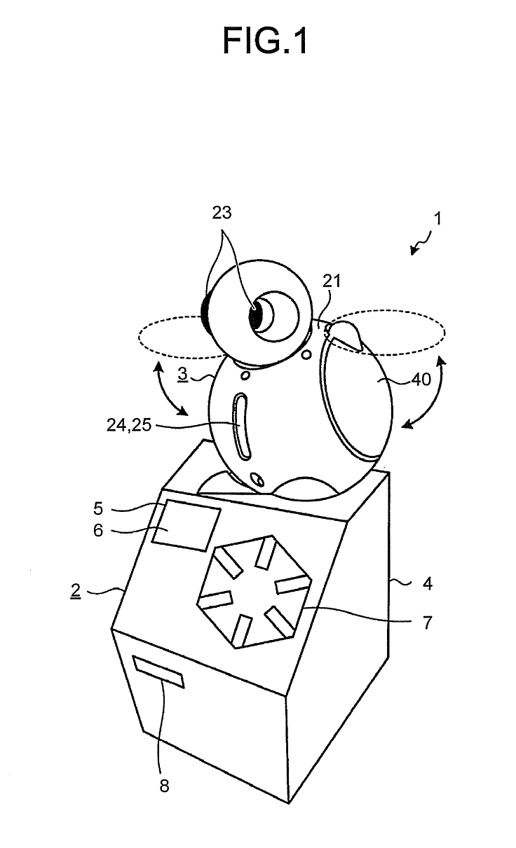

FIG. 1 is a perspective view illustrating the appearance of an information processing apparatus 1 according to an embodiment. The information processing apparatus 1, which is an information terminal (signage) used in a shopping mall to provide guidance, advertisement, offer and response in more than two languages for a user facing the terminal. The information processing apparatus 1 comprises an information providing device 2 that can be simply operated to provide various kinds of information for a customer, and an assist (supporting) device 3 for assisting (supporting) the customer in operating the information providing device 2.

The information providing device 2 is described first. The information providing device 2 serves as a point service device. As shown in FIG. 1, in the information providing device 2, the assist device 3 is placed on the upper surface of a casing 4. A charging station (not shown) is arranged on the upper surface of the casing 4 of the information providing device 2 to charge the assist device 3.

Moreover, on the casing 4, the information providing device 2 further comprises a display 5 consisting of a Liquid Crystal Display (LCD) or organic EL display which displays given information in the form of a color image; a touch panel 6, for example, a resistive-film type touch panel, which is overlapped with the display surface of the display 5; a card reader/writer 7 for transmitting data with a membership card serving as a non-touch wireless IC card or a cell phone; and a dispensing opening 8 for dispending a discount coupon or gift exchange coupon described later. The card reader/writer 7 establishes a wireless communication with the non-contact IC card or cell phone to read/write information from or to the non-contact IC card or cell phone. In an example, cash-equivalent electronic money or a membership number is stored in the non-contact IC card or cell phone. In FIG. 1, an antenna (not shown) is built in the card reader/writer 7 to establish a wireless communication with the non-contact IC card or cell phone.

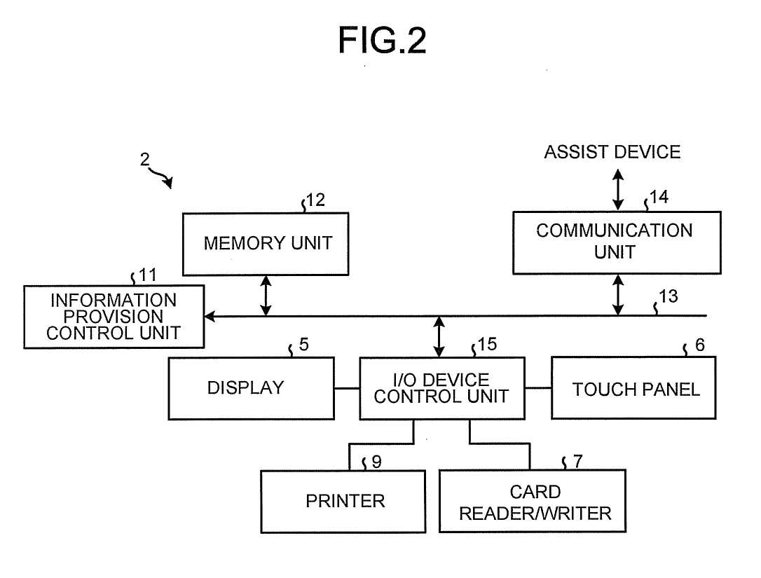

The structure of the electrical equipment system of the information providing device 2 is arranged as shown in FIG. 2, which is a block diagram illustrating the structure of the electrical equipment system of the information providing device 2.

As shown in FIG. 2, the information providing device 2 comprises an information provision control unit 11 consisting of a computer composition in which a Central Processing Unit (CPU), a Read Only Memory (ROM) for storing a control program, and a Random Access Memory (RAM) are arranged and a memory unit 12 consisting of a nonvolatile ROM or Hard Disk Drive (HDD), to perform a mutual online communication with the assist device 3 through a communication unit 14 connected with the information providing device 2 via a bus line 13.

Further, the information provision control unit 11 is connected with the display 5, the touch panel 6 and the card reader/writer 7 via the bus line 13 and an I/O device control unit 15 and is also connected with a printer 9. The printer 9 is built in the casing 4 and controlled by the information provision control unit 11 to print discount coupons or gift exchange coupons that are then dispensed from the dispensing opening 8. The display 5 controlled by the information provision control unit 11 displays, for a user, visual guidance information in the form of image or message.

Moreover, by executing the control program stored in the ROM by the CPU, the information provision control unit 11 performs a point addition processing after acquiring a membership number through the non-contact IC card or cell phone held by a customer on the card reader/writer 7.

In addition to general point services, the point addition processing further includes a visiting point service, which provides a certain number of points for a customer who comes to the shopping mall, regardless of whether or not the customer purchases commodities. Generally, the visiting point service is only provided for a customer once in a day. Moreover, the point addition processing can further include a lottery, such as a slot game etc., to provide a visiting points corresponding to the result of the lottery. The information provision control unit 11 issues a discount coupon or gift exchange coupon etc., when a certain number of points are achieved in the point addition processing.

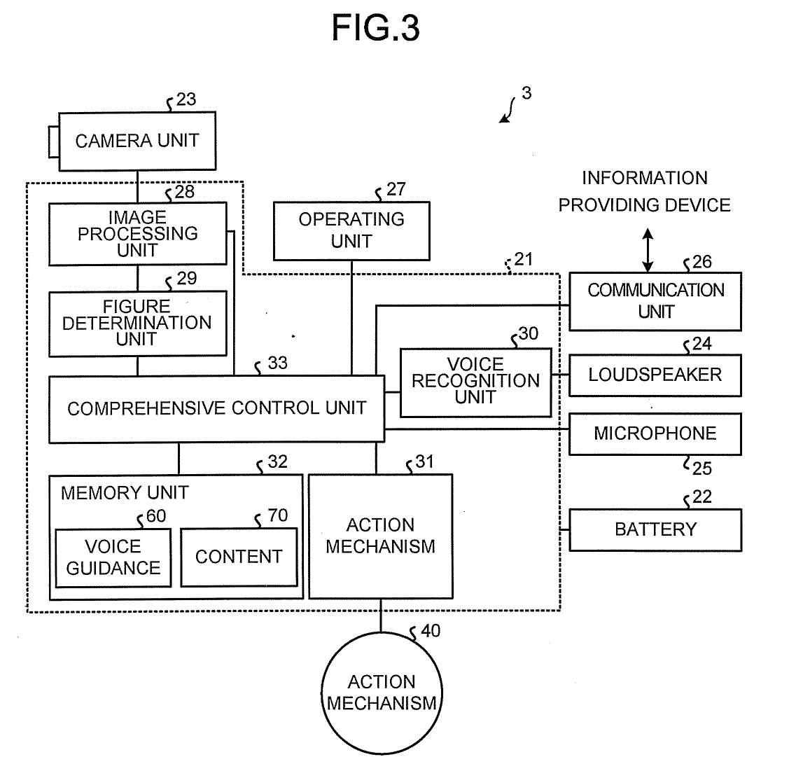

Next, the assist device 3 is described. FIG. 3 is a functional block diagram illustrating the structure of the assist device 3. As shown in FIG. 1 and FIG. 3, the assist device 3 mainly comprises a casing 21 which forms the outline of the assist device 3, and a battery 22 serving as a drive source. The assist device 3 having no wires for receiving an external power supply runs with the battery 22. That is, the assist device 3 is automatically charged by contacting the battery 22 thereof with the charging pole of the charging station (not shown) arranged on the upper surface of the casing 4 of the information providing device 2.

In addition, as shown in FIG. 1 and FIG. 3, the assist device 3 comprises a camera unit 23, a microphone 24, a loudspeaker 25, a communication unit 26 and an operation unit 27 outside the casing 21 and an image processing unit 28, a figure determination unit 29, a voice recognition unit 30, an action control unit 31, a memory unit 32 and a unified control unit 33 for solely controlling the aforementioned hardware in the casing 21. The unified control unit 33 is a computer construction consisting of a CPU, a ROM for storing control programs and a RAM.

The assist device 3 can be sold or transferred while programs are stored in the ROM, or the programs are freely installed in the assist device 3 that are stored in a storage medium or sold or transferred through the communication of a communication line. Further, all kinds of mediums can be used as the storage medium, such as magnetic disc, magneto-optical disc, optical disc or semiconductor memory.

The camera unit 23 comprises an image pickup component such as CCD sensor for shooting the space surrounding the assist device 3. The image processing unit 28 processes the image shot by the camera unit 23 to convert the shot image to a digital image.

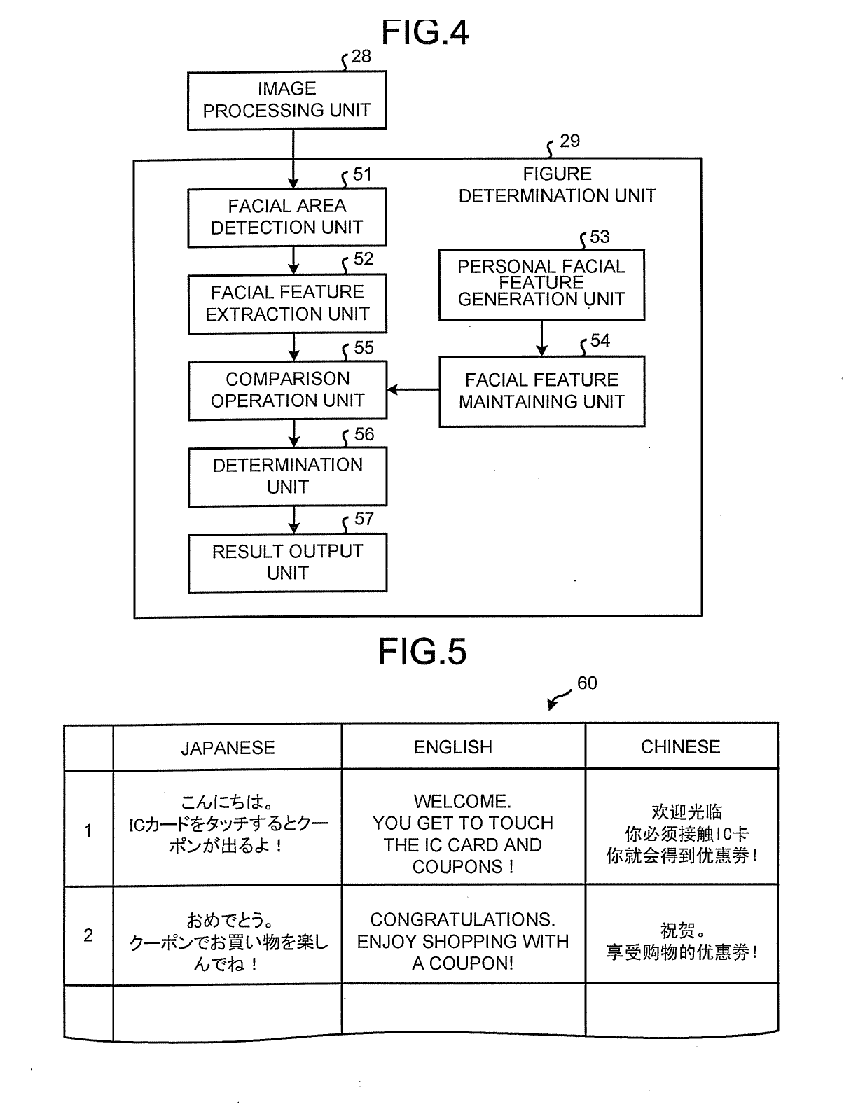

The figure determination unit 29 serves as an attribute determination unit for determining age and gender of the figure (person) standing before the information processing apparatus 1 according to the image processed by the image processing unit 28. The determination can be made using the technology disclosed in Japanese Patent Application Publication No. 2005-165447. In brief, as shown in FIG. 4, the figure determination unit 29 comprises a facial area detection unit 51, a facial feature extraction unit 52, a personal facial feature generation unit 53, a facial feature maintaining unit 54, a comparison operation unit 55, a determination unit 56 and a result output unit 57. Moreover, the figure determination unit 29 may also be realized by the CPU of the unified control unit 33 performing processing according to a program.

The facial area detection unit 51 detects the facial area of a figure according to the image input by the image processing unit 28. The facial feature extraction unit 52 extracts the facial feature information of the facial area detected by the facial area detection unit 51.

The personal facial feature generation unit 53 generates a facial feature information from persons in a broad age range in each sex in advance. The facial feature maintaining unit 54 stores (maintains) the personal facial feature information generated by the personal facial feature generation unit 53 corresponding to the age and the gender of the figure from which the personal facial feature information is acquired.

The comparison operation unit 55 compares the facial feature information extracted by the facial feature extraction unit 52 with the plurality of personal facial feature information maintained in the facial feature maintaining unit 54 to calculate the similarity of these information and output the age information and the gender information that are maintained in the facial feature maintaining unit 54 corresponding to the similarity which exceeds a predetermined threshold value and the personal facial feature information which achieves the above similarity.

The determination unit 56 determines the age and the gender of the figure according to the similarity, the age and the gender output from the comparison operation unit 56. Then, the result output unit 57 outputs the determination result of the determination unit 56.

Moreover, as shown in FIG. 1 and FIG. 3, an action unit 40 is arranged on a part of the casing 2 of the assist device 3, and an action control unit 31 controls the drive of the action unit 40. The action unit 40 is, for example, a feather-shaped structure herein that acts like a wing moving in the vertical (up and down) direction under the control of the action control unit 31.

The loudspeaker 25 outputs a voice message or a sound notice to the user. The communication unit 26 is arranged to exchange information with the information provision control unit 11. The microphone 24 collects sound or voice around the assist device 3. The operation unit 27 is provided for a user to input information by operating a keyboard based on the information output from the loudspeaker 25.

By taking the voice signal input from the microphone 24 as an input, the voice recognition unit 30 generates a voice recognition result such as words or phrases corresponding to the collected voice. The voice recognition unit 30 compares the voice signal input from the microphone 24 with a language dictionary, thereby recognizing the content spoken by the user. Moreover, the voice recognition unit 30 has a dictionary memory in which dictionaries (Japanese dictionary, English dictionary and Chinese dictionary) are stored corresponding to languages Japanese, English and Chinese.

Voice guidance 60 and content 70 are stored in the memory unit 32, and the information for assisting the user in operating the operation information provision device 2 is stored in the memory unit. FIG. 5 is a schematic diagram illustrating an example of the voice guidance 60. As shown in FIG. 5, the voice guidance 60 is provided to assist the user in carrying out various processing, and three languages including Japanese, English and Chinese are set for each piece of voice guidance information applied with a guidance number. For instance, for the voice guidance information ‘Hello! Please touch IC card to here, coupon can print out! ’ in Japanese, there is also provided an English version and a Chinese version. Similarly, the content 70 is provided for the purpose of an advertisement to users, and Japanese, English and Chinese are set for each piece of advertisement content applied with a content number. Moreover, voice guidance information and advertisement content information may be acquired through a voice synthesis process of converting text information to a voice signal or by playing back a pre-prepared voice signal. As the voice synthesis technology has been developed and sold in the market in software form, related description is saved here.

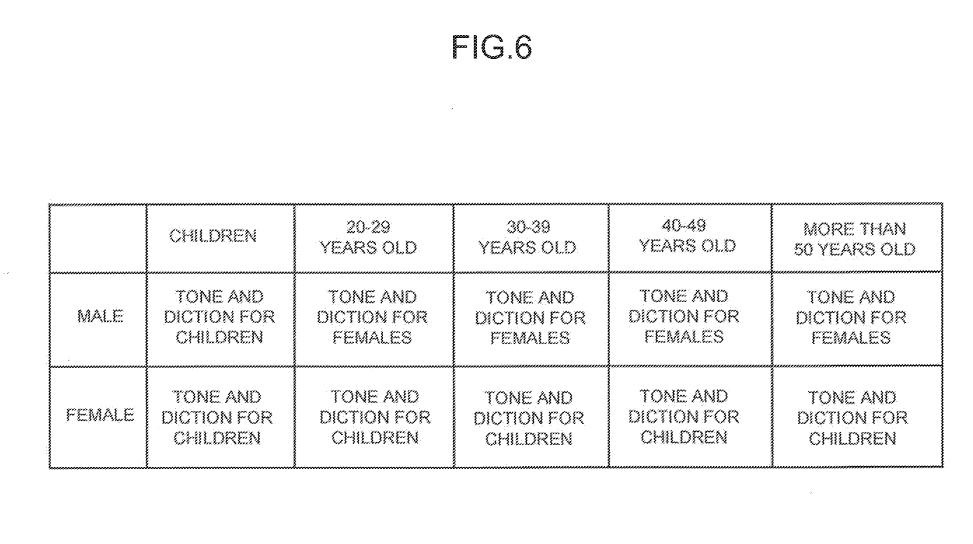

Moreover, voice (tone and diction) can be changed during the voice synthesis process according to the age and the gender (figure attribute) that are determined by the determination unit 56 and then output from the result output unit 57. According to the voice synthesis, a diction suitable for the compared tone can be easily set and changed. For instance, by sounding a female voice for males and children voice for females, more attentions can be attracted and more affinity can be produced. FIG. 6 shows an example of a tone and diction setting suitable for the age and the gender of figures.

The tone and diction of voice guidance information or advertisement content information is not limited to be changed by the voice synthesis based on the age and the gender (figure attribute) of a figure, and recorded voice can also be used which, however, leads to a great quantity of operations and data.

Next, the functions of the information processing apparatus 1 are described. As mentioned above, the information processing apparatus 1 is an information terminal (signage) for providing guidance, advertisement, offer and response for the user facing the terminal, using three languages. In the conventional information terminal 1 capable of coping with a plurality of languages, guidance, advertisement, offer and response are provided in the language selected. That is, in such information terminal 1, when there is a need to select a language via a voice input, for example, to change English currently set to Japanese, the user speaks English to make the change.

However, in this case, a user who cannot speak English cannot make the change. Additionally, if the user pronounces inarticulately, it is highly likely that the input voice is recognized incorrectly, resulting in that the language cannot be changed.

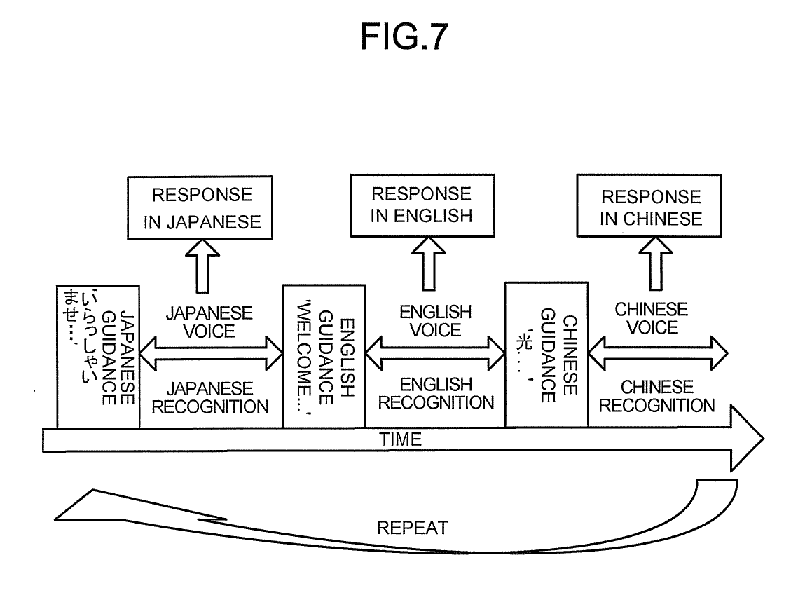

Therefore, as shown in FIG. 7, the information processing apparatus 1 periodically switches languages (e.g. Japanese, English and Chinese) at given time intervals and provides guidance and response in the language last used by the user in making a response.

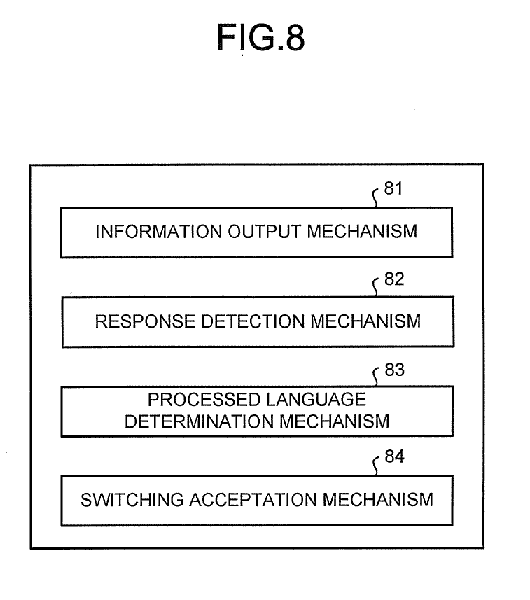

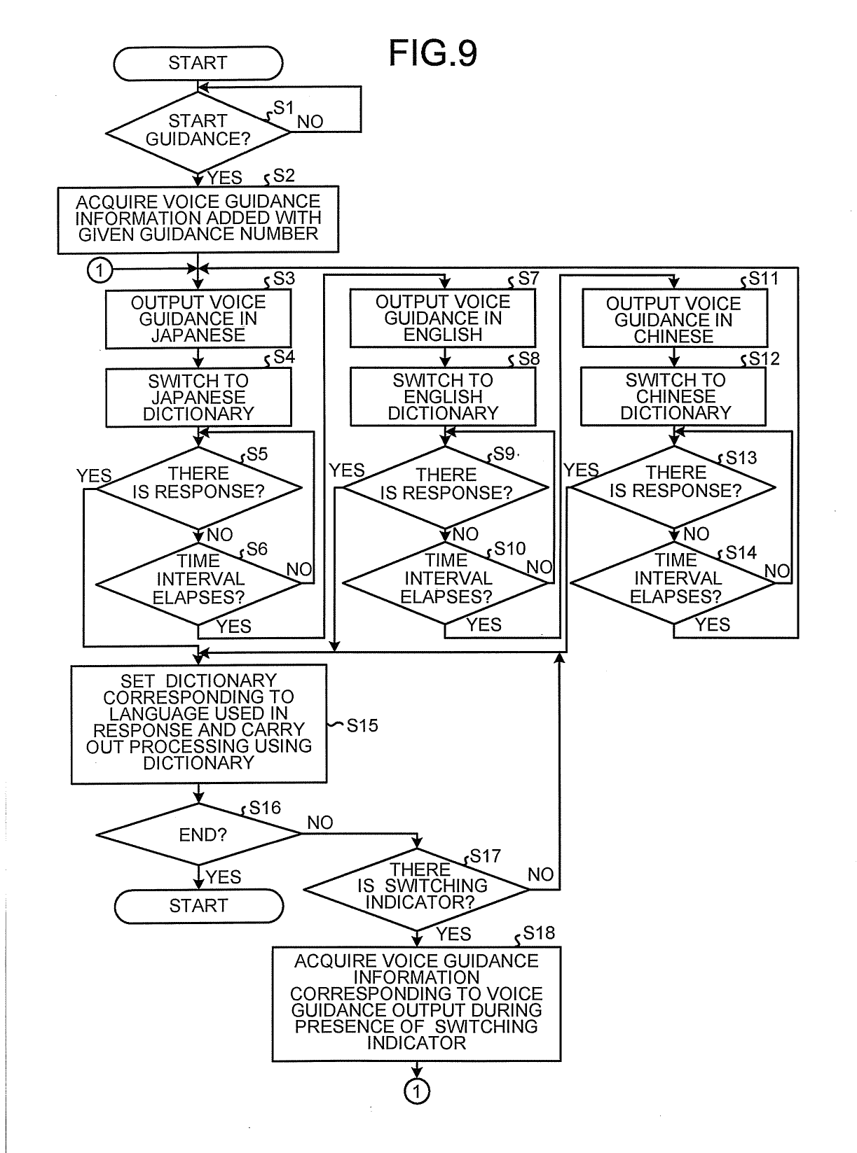

FIG. 8 is a functional block diagram illustrating the functional components for a language switching processing, and FIG. 9 is a flow chart of a language switching process.

The program executed by the CPU of the unified control unit 33 of the assist device 3 is constituted as a modular structure shown in FIG. 8 including an information output unit 81, a response detection unit 82, a processing language determination unit 83 and a switching receiving unit 84. As an actual hardware structure, the CPU reads the program from the ROM and then executes the program, thereby loading the aforementioned components on the RAM and generating the information output unit 81, the response detection unit 82, the processing language determination unit 83 and the switching receiving unit 84 on the RAM.

As shown by the flow chart of FIG. 9, the information output unit 81 determines the start of the voice guidance when the figure determination unit 29 determines the figure or the operation unit 27 receives the key operation by the user (Act S1: Yes), the information output unit 81 acquires voice guidance information added with a guidance number (‘1’ at the beginning) from the voice guidance 60 (Act S2)

Then, the information output unit 81 successively switches voice guidances of three languages (Japanese, English and Chinese) in the voice guidance information at given time intervals and outputs the voice guidance from the loudspeaker 25 and synchronously switches the dictionaries (Japanese dictionary, English dictionary and Chinese dictionary) of the voice recognition unit 30 corresponding in response to the language switching of the voice guidance of three languages (Acts S3-S14). Here, the time interval containing a given language switching wait time is set to be about 10 seconds. The given wait time is contained in the time interval so that the given time following the voice guidance is guaranteed to be the response time of the user.

Moreover, the time interval may be changed according to the operation (received by the operation unit 27) on an interval time setting button by the user. For instance, in the case where the user poor in English attempts to make a response in English in order to practice speaking English, the interval time can be prolonged to increase the response time.

When switching languages at the time interval containing the given wait time, if the user returns a response in a language corresponding to the language of the voice guidance and the voice of the response is recognized by the voice recognition unit 30 (Act S5: Yes, Act S9: Yes and Act S13: Yes), the response detection unit 82 determines that the language recognized is a language that can be understood by the user.

Then, the processing language determination unit 83 sets a dictionary (Japanese dictionary, English dictionary or Chinese dictionary) of the voice recognition unit 30 corresponding to the language in the response and performs processing (e.g. guidance or response) using the language set (Act S15). For instance, the processing language determination unit 83 orderly acquires and outputs the voice guidance information which is applied with a guidance number of after voice guidance which is responded.

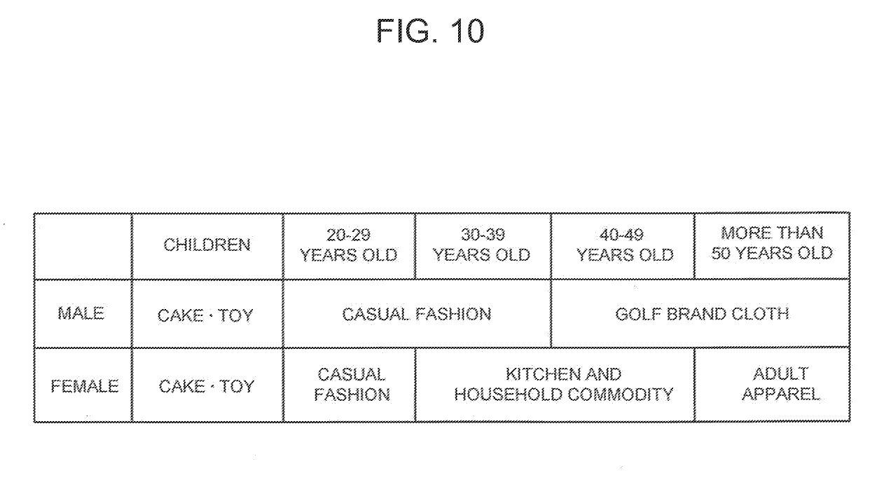

The processing executed in Act S15 using the determined language further includes advertisement. In an effective advertisement, tone, diction and advertisement content are changed according to the age and gender of a figure (figure attribute). Therefore, in the information processing apparatus 1 of this embodiment, advertisement content is selected according to the age and the gender of a figure (figure attribute) that are determined by the determination unit 56 and then output from the output unit 57, and then processed through a voice synthesis to generate a voice based on the text of the selected advertisement content. Advertisement is made for the products in demand, for example, fashionable commodities for young females and specialty store of standard brand suit aiming at middle-aged males. FIG. 10 shows an example of an advertisement content setting according to the age and the gender of a figure (figure attribute).

Act S15 is repeatedly executed until a guidance or advertisement end is instructed (Act S16: Yes) or a language switching is instructed (Act S17: Yes). The CPU of the unified control unit 33 returns to execute Act S1 to wait for voice guidance when a guidance or advertisement end is instructed. The instruction of the guidance or advertisement end may be issued at the time that no response is performed in a given time, or that the figure determination unit 29 determines that no figure is contained in the image shot by the camera unit 23, or that an operation on a response end key by the user is received by the operation unit 27, or that a keyword (e.g. ‘Bye-bye’) is recognized by the voice recognition unit 30.

Moreover, before a guidance or advertisement end is instructed (Act S16: No), when the switching receiving unit 84 receives the keyboard operation of the user on a language switching key from the operation unit 27 (Act S17: Yes), the information output unit 81 acquires the voice guidance information corresponding to the voice guidance or the advertisement content information corresponding to the advertisement content output at the time that the switching instruction is issued (Act S18), and switches the languages (Japanese, English and Chinese) of the guidance or advertisement content at given time intervals. In addition, the information output unit 81 outputs the guidance or advertisement content from the loudspeaker 25 in the switched language, and also switches the dictionaries (Japanese dictionary, English dictionary or Chinese dictionary) of the voice recognition unit 30 corresponding to the switching in the languages of the guidance or advertisement content together with the output of the guidance or advertisement content (Act S3-Act S14)

In the information processing apparatus 1 of this embodiment, the guidance or advertisement content for assisting the user in operating the information providing device 2 is provided in Japanese, English and Chinese voice, but it should be appreciated that the content can also be provided in the form of text, but not limited to voice, for instance, the content can be displayed on, for example, the display 5. In the case where the guidance or advertisement content for assisting the user in operating the information providing device 2 is displayed on the display 5 in the form of text, the user can request information using the touch panel 6 or by making a voice response. Moreover, in the case where the guidance or advertisement content for assisting the user in operating the information providing device 2 is displayed on the display 5 in the form of text, a button is displayed on the touch panel 6 or the color of the displayed content are changed in given time intervals to enable the voice recognition for the current language.

Moreover, the guidance or advertisement content for assisting the user in operating the information providing device 2 may be indicated in voice and displayed in text simultaneously. Moreover, in the case where the guidance or advertisement content is indicated in voice and displayed in text, the languages used in the voice indication and the text display may be different from one the other. For instance, the guidance or advertisement content may be indicated in Japanese and displayed in English.

Moreover, in the information processing apparatus 1 of this embodiment, while advertisement content is selected, the tone and diction of the voice guidance or advertisement content is changed according to the age and the gender of a figure (figure attribute) that are determined by the determination unit 56 and then output from the output unit 57, but it should be appreciated that the present invention is not limited to this. For instance, the information output unit 8 can change the actions of the action unit 40 formed on a part of the casing 21 of the assist device 3 by controlling the action control unit 31 according to the age and the gender (figure attribute) that are determined by the determination unit 56 and then output from the result output unit 57. In this way, the presentation effect is dynamically shown according to figure attributes to attract more customers.

In this embodiment, in order to assist the user in carrying out various processing, there is provided an information output unit 81 which outputs guidance information set in a plurality of languages by switching languages in given time intervals, a response detection unit 82 which detects a response to the guidance information when the guidance information is output while languages are switched, and a processing language determination unit 83 which determines the language used in the response to the detected guidance information as a processing language, and thus, voice guidance can be selected corresponding to the language (Japanese, English and Chinese) that can be understood by the user, without carrying out a specific selection operation.

Moreover, according to this embodiment, an attribute determination unit 29 which determines the attributes of the figure (user) facing the information processing apparatus 1 according to the shot image showing the space around the information processing apparatus 1, and an information output unit 81 which changes voice according to the figure attributes determined by the attribute determination unit 29 and outputs, in the form of voice, guidance information for assisting the user in carrying out various processing are also provided, and thus, the presentation effect is dynamically shown according to the figure attributes to attract more customers.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an information output unit configured to switch a plurality of languages in a guidance information set by the plurality of languages at each given time interval and output the guidance information in the changed language;
a response detection unit configured to detect a response to the guidance information when the guidance information is output while the languages are switched; and
a processing language determination unit configured to determine, as a processing language, the language in the response to the guidance information detected by the response detection unit.

2. The apparatus according to claim 1, wherein
the response detection unit detects a response to the guidance information through a voice recognition using language dictionaries; and
the processing language determination unit switches the language dictionaries according to the language in the response detected by the response detection unit.

3. The apparatus according to claim 1, wherein
the response detection unit detects a response to the guidance information according to the operation of the user.

4. The apparatus according to claim 1, wherein
the given time interval for switching the language is set through the information output unit.

5. The apparatus according to claim 1, further comprising:
a switching receiving unit configured to receive a switching instruction of the language after the language is determined by the processing language determination unit; wherein
the information output unit switches the language at given time intervals while outputs the guidance information which is outputted at the time the switching instruction is issued in a case that the switching instruction of language is received by the switching receiving unit after the language is determined by the processing language determination unit.

6. A method, comprising:
switching a plurality of languages in a guidance information set by the plurality of languages at each given time interval and outputting the guidance information in the changed language;
detecting a response to the guidance information when the guidance information is output while the languages are switched; and
determining, as a processing language, the language in the response to the guidance information detected.
